(19) United States
(12) Patent Application Publication
(10) Pub. No.: US 2007/0133355 A1
(43) Pub. Date: Jun. 14, 2007

(54) Timepiece and spring thereof

(75) Inventors: Tatsuo Hara, Nagano-ken (JP); Kazuma Miyata, Kagoshima-ken (JP)

Correspondence Address: GLOBAL IP COUNSELORS, LLP, 1233 20TH STREET, NW, SUITE 700, WASHINGTON, DC, 20036-2680, US

(73) Assignee: Seik Epson Corporation, Tokyo (JP)

(21) Appl. No.: 10/578,144

(22) PCT Filed: Nov. 1, 2004
(86) PCT No.: PCT/JP04/16499

§ 371 Date: May 3, 2006

(30) Foreign Application Priority Data
Nov. 7, 2003 (JP) 2003-378449

(51) Int. Cl. G04B 1/10

(52) U.S. Cl. 368/140

(57) ABSTRACT

[Object] To provide a timepiece spring whereby it is possible to ensure high precision and stable operation of precision mechanisms such as timepieces, and to provide a timepiece spring, a mainspring, a hairspring, and a timepiece wherein long-term operation can be ensured when the spring is used as a power source.

[Means] A mainspring used as a source to power a drive source is formed from a special titanium alloy and has an S-shape when freely spread out, wherein the inflection point at which the curving direction of the freely spread-out shape changes is formed farther inward than the midpoint of an inner end at the end of the winding side and an outer end at the end opposite the inner end. The titanium alloy constituting the present invention has high tensile stress and a low average Young's modulus, making it possible to increase the mechanical energy accumulated in the mainspring 31.

### TECHNICAL FIELD

The present invention relates to a timepiece spring, a mainspring, a hairspring, and a timepiece.

### BACKGROUND ART

In conventional practice, various springs are used in precision mechanisms, including timepieces. For example, timepieces are known to have springs for fixing a quartz oscillator in a quartz oscillation timepiece in an urged state, mainsprings as drive sources in the driving mechanism of a timepiece, click springs provided to prevent recoil when the mainspring is wound, hairsprings for urging balance in a mechanical timepiece, and the like.

Also, spring material and mainspring material composed of carbon steel, stainless steel, a cobalt alloy, a copper alloy, or the like have been employed in conventional practice as the materials to be used for such springs, but the following problems (i) to (iii) have been encountered with such use.

(i) First, with a spring for fixing a quartz oscillator in an urged state, a problem has been encountered whereby the pace of the quartz oscillator is caused to deviate by the urging force of the spring. Specifically, problems have been encountered in that the 32 kHz signal cycle of quartz oscillation either gains or lags behind due to the fluctuation in the urging force of the spring, which causes deviation in the precision of the timepiece that uses this signal as a standard signal. Therefore, springs for fixing the quartz oscillator that have little variation in urging force have been in demand.

(ii) Also, with a hairspring for urging a balance that constitutes the governor of a mechanical timepiece, the urging force fluctuates when the Young's modulus changes as a result of a change in temperature, the oscillation cycle of the balance changes as well, and this change in the oscillation cycle of the balance greatly affects the precision of the mechanical timepiece. Therefore, a material wherein the Young's modulus does not change due to temperature variations is preferably used for the hairspring.

(iii) Furthermore, a mainspring that constitutes the source for powering the drive source of a timepiece or the like must satisfy the mutually exclusive properties of providing a long-term operation for the drive source and yielding a drive source that is smaller in size. Specifically, for example, the drive source of a timepiece includes a mainspring that serves as the power source, a barrel that houses this mainspring, and a train wheel that meshes with the barrel and transmits the mechanical energy of the mainspring. Rotational force based on the recoil of the wound mainspring is utilized to rotate the pointers of the timepiece via the train wheel or another such transmitting device.

Accordingly, in order to solve the aforementioned problems, springs composed of a titanium alloy, for example, and mainsprings and hairsprings composed of these springs have recently been researched (for example, Prior Art 1).

It is known that there is a proportional relationship between the number of turns and the output torque of a mainspring that serves as the power source of a drive source. Assuming that the mainspring has a rectangular cross section with a thickness t and a width b, this relationship can be expressed by Eq. (1) shown below, wherein T is the torque outputted by the mainspring, N is the number of loops (number of turns) of the mainspring, E is the Young's modulus, L is the total length of the mainspring.
Eq. 1
T=(Et³bπ/6L)×N (1)

The total length L, thickness t, and width b of the mainspring are determined by the size of the barrel for housing the mainspring. If it is assumed that the internal radius of the barrel is R and the absolute radius of the barrel is r, it is possible to derive the total length L of the mainspring is from Eq. (2) shown below. It is clear from Eq. (2) that there is an inverse proportional relationship between the total length L and the thickness t of the mainspring.
Eq. 2
L=π(R²−r²)/2t (2)

The mechanical energy accumulated by the mainspring can be determined by integrating the output torque T from Eq. (1) with respect to the number of turns N, and since both the total length L and thickness t of the mainspring are taken into account in Eq. (1), the energy of the mainspring is conventionally adjusted by adjusting L and t. Specifically, the maximum number of turns Nmax of the mainspring can be increased if the thickness t of the mainspring is reduced to increase the total length L of the mainspring. Conversely, it has been possible to increase the value of the output torque T by reducing the total length L of the mainspring to increase the thickness t of the mainspring.

### PRIOR ART 1

International Publication WO99/12080

### DISCLOSURE OF THE INVENTION

[Problems the Invention Is Intended to Solve]

With such determining methods, however, the thickness t and total length L of the mainspring are limited by the capacity of the housing space in the barrel, as is made clear from Eq. (2). Therefore, using a mainspring capable of long-term operation has had problems in that the drive mechanism with the mainspring cannot be reduced in size because the barrel must inevitably be enlarged to increase the housing space.

Consideration has also been given to using a mainspring material with a high Young's modulus and manufacturing a mainspring capable of outputting a high torque even with a small thickness t. With such a mainspring, however, it is difficult to ensure sufficient toughness, and the durability of the mainspring is therefore limited.

An object of the present invention is to provide a timepiece spring whereby the precision mechanisms of the timepiece can be ensured to have high precision and stable operation, and also to provide a timepiece spring whereby long-term operation can be ensured when the spring is utilized as a power source, and to provide a mainspring, hairspring, and timepiece containing this timepiece spring.

[Means For Solving The Problems]

In order to solve the problems previously described, the timepiece spring of the present invention is characterized in being made of a titanium alloy containing one or more vanadium group (Group Va) elements, wherein the remainder is composed substantially of titanium (Ti), the average Young's modulus is 100 GPa or less, and the tensile strength is 1000 MPa or greater.

As previously described, the timepiece spring of the present invention has a basic configuration of a titanium alloy containing one or more vanadium group (Group Va) elements, wherein the remainder is composed substantially of titanium (Ti) (hereinafter referred to simply as “titanium alloy” or “special titanium alloy”).

Aside from vanadium, the vanadium group (Group Va) herein may also include niobium (Nb), tantalum (Ta), or the like, and the titanium alloy can contain only one of these elements or a combination of two or more of these elements. These elements are known as beta-phase stabilized elements, but this does not mean that the entire titanium alkoxide is limited to beta alloys.

Also, the vanadium group (Group Va) is preferably contained in an amount of 20 to 80 mass, and more preferably 30 to 60 mass %, in relation to the titanium alloy that constitutes the timepiece spring of the present invention. The titanium alloy can be ensured to have a low Young's modulus without a reduction in specific strength by keeping the vanadium group (Group Va) content in this range. It is sometimes difficult to bring the average Young's modulus to the desired level of 100 Gpa or less when the vanadium group (Group Va) content is less than 20 mass %. Also, when the vanadium group (Group Va) content exceeds 80 mass %, the density of the titanium alloy increases, so the specific strength of the titanium alloy is sometimes reduced.

The titanium alloy may also contain one or more metal elements selected from the group composed of zirconium (Zr), hafnium (Hf), and scandium (Sc). Of these metal elements, zirconium (Zr) and hafnium (Hf) are effective for lowering the Young's modulus and increasing the strength of the titanium alloy. Along with the vanadium group (Group Va) elements, scandium (Sc) can uniquely reduce the bonding energy between titanium atoms and to promote a reduction in the Young's modulus when dissolved to form a solid solution in titanium (Ti). 30 to 60 mass % of these metal elements is preferably contained when the entire titanium alloy is 100 mass %, and the effects of these elements are suitably manifested when their content is kept in this range.

The titanium alloy may also contain one or more of the elements oxygen (O), carbon (C), and nitrogen (N), which are preferred because they are interstitial solid solution reinforcing elements, and can therefore improve the strength of the titanium alloy. 2 mass % or less of oxygen (O), carbon (C), and nitrogen (N) is preferably contained when the entire titanium alloy is 100 mass %, and the strength of the titanium alloy can be adequately improved when the content of oxygen (O) and carbon (C) is kept in this range.

The titanium alloy may also contain boron (B), and it is preferable to add boron (B) because it can improve the mechanical material characteristics and the hot workability of the titanium alloy. 2 mass % or less of boron (B) is preferably contained when the entire titanium alloy is 100 mass %, and the mechanical material characteristics and the hot workability of the titanium alloy can be adequately improved by keeping the boron (B) content in this range.

The titanium alloy may also contain one or more metal elements selected from the group composed of chromium (Cr), molybdenum (Mo), manganese (Mn), iron (Fe), cobalt (Co), nickel (Ni), tin (Sn), and aluminum (Al), and it is preferable to add these metal elements because they can improve the strength (including room temperature strength) and hot forgeability of the titanium alloy.

The compositional elements previously described can be arbitrarily combined in a specific range according to the required properties of the spring, and the titanium alloy may be prepared by adding other elements within a range that does not compromise the effects of the present invention.

The titanium alloy constituting the timepiece spring of the present invention is defined as an alloy containing titanium Ti), but the titanium (Ti) content is not specified. Consequently, in the present invention, the alloy is defined as a titanium alloy as long as it is an alloy that contains titanium (Ti), even if the content of components other than titanium (Ti) exceeds half the content of the entire alloy (50 mass % or more).

The method for manufacturing the titanium alloy composed of the components previously described is not particularly limited, and the titanium alloy can be manufactured using dissolution, casting, sintering, or other such conventionally known means. Also, the material characteristics of the resulting titanium alloy can be adjusted by performing cold working, hot working, heat treatment, and other steps during the manufacturing. The titanium alloy constituting the timepiece spring of the present invention can also be manufactured in a simple manner by using a titanium alloy manufacturing method such as the one disclosed in JP-A No. 2002-249836, for example.

The titanium alloy constituting the timepiece spring of the present invention is characterized in being composed of a titanium alloy with an average Young's modulus of 100 GPa or less and a tensile strength of 1000 MPa or greater, and it is preferable that the average Young's modulus be 90 GPa or less and the tensile strength be 1300 MPa or greater, or that the average Young's modulus be 60 GPa or less and the tensile strength be 1000 MPa or greater.

The term “average Young's modulus” used herein denotes the incline (the slope of a tangent to a curve) of a stress-strain diagram, obtained by tensile tests, at a stress position corresponding to half the tensile elastic limit strength, as disclosed in JP-A No. 2002-249836, for example.

Specifically, the reason that the titanium alloy with the aforementioned composition is used as the spring material for the timepiece is to obtain a timepiece spring material wherein the tensile strength is 1000 MPa or greater and the average Young's modulus is 100 Gpa or less. Specifically, the following results are obtained by a comparison of maximum tensile stress (σmax) and average Young's modulus E between conventional mainspring material and a spring composed of a special titanium alloy.

(Composition of conventional mainspring material)

| Chemical composition | Co 30-45%, Ni 10-20%, Cr 8-15%, | |
|---|---|---|
| (mass %): | C < 0.03%, W 3-5%, Mo 3-12%, Ti 0.1-2%, | |
| | Mn 0.1-2%, Si 0.1-2%, Fe remainder | |
| | σmax (MPa) | E (GPa) |
| Conventional material | 2000 | 200 |
| Titanium alloy spring | 1500 | 80 |

When a timepiece spring composed of such a special titanium alloy is used, the average Young's modulus is low but the maximum tensile stress is high, so the allowable stress is high, and a high urging force is achieved even compared to a spring of conventional material with the same shape, which is preferable when reducing the size of the precision mechanisms.

Also, since the timepiece spring is composed of a special titanium alloy, wire or a ribbon material can be easily manufactured using a single roll process, twin roll process, in-rotating-water spinning process, or other such methods, and the steps for manufacturing the spring can be simplified.

Furthermore, since the special titanium alloy constituting the timepiece spring has superelastic properties that provide the alloy with excellent elastic modification capabilities, and superplastic properties that provide the alloy with excellent cold workability even at room temperature, it is possible, for example, to utilize this type of cold workability and to process easily the titanium alloy into the desired shape.

Furthermore, the special titanium alloy has adequate corrosion resistance, so the need for anticorrosive coating can be eliminated for some of the locations at which the timepiece spring is used.

When the timepiece spring composed of a special titanium alloy is used as the urging means for fixing the quartz oscillator in place, deviation of the signal cycle of the quartz oscillator can be prevented due to the following reasons.

Specifically, as previously described, since the spring (titanium alloy spring) composed of a special titanium alloy has a low average Young's modulus compared to a spring made of a conventional material, the relationship between the deflection amount ε and the urging force F of the spring describes a graph G2 with a gentler slope than the graph G1 of a spring made of a conventional material, as shown in FIG. 1.

If ε1 is the deflection amount of a spring of conventional material for applying the urging force F0 necessary to fix a quartz oscillator in place, and ε2 is the deflection amount of the titanium alloy spring, and if the deflection amount ε1 and deflection amount ε2 of the two springs vary by σ, then a comparison of the fluctuations df1 and df2 in the urging force F0 shows that the fluctuation df2 in the urging force of the titanium alloy spring is smaller.

Consequently, if the titanium alloy spring is used as the urging means for fixing the quartz oscillator in place, it is possible to reduce variation in the urging force, to suppress deviations in the cycle of the quartz oscillator, and to make the timepiece more precise.

Also, if a timepiece spring composed of a special titanium alloy is used as a hairspring for urging a balance constituting the governor of a mechanical timepiece, the average Young's modulus varies less with varying temperature than in the case of carbon steel or the like, which is the material for common hairsprings. Therefore, changes in the oscillation cycle of the balance that accompany variations in the urging force are reduced when changes in temperature occur, and the mechanical timepiece can be made more precise.

Furthermore, when a timepiece spring composed of a special titanium alloy is used as the source for powering a drive source, specifically, when a mainspring composed of a special titanium alloy is used, long-term operation of the power source can be achieved based on the following considerations.

Specifically, the deflection of a mainspring 31 (in terms of thickness t, width b, and length L) that satisfies the relationship in Eq. (1) above can be approximated as the deflection of a cantilevered supporting beam wherein the inner end 311 rigidly joined to the barrel stem 33, and the outer end 312 at the other end is in a free state, as shown in FIG. 2.

The deflection angle α (rad) in FIG. 2 can be expressed by the following Eq. (3), wherein r is the deflection radius of the mainspring 31.
Eq. 3
r=L/α (3)

The number of turns N of the mainspring 31 can be expressed by the following Eq. (4) using the deflection angle α.
Eq. 4
N=α/2π (4)

Therefore, Eq. (1) can be modified into the following Eq. (5) based on Eqs (3) and (4).
Eq. 5
T=(bt³E/12L)×α (5)

The energy U accumulated by the deflection of the mainspring 31 can be calculated by integrating the bending moment applied to the mainspring 31, specifically, the output torque T of the mainspring 31, with respect to α, and is expressed by the following Eq. (6).

$$Eq . 6 \\ \begin{matrix}U = \int T α \\ = \int ( b {t}^{3} E / 12 L ) \times α ⅆ α \\ = ( b {t}^{3} E / 24 L ) \times {α}^{2}\end{matrix} \qquad ( 6 )$$

Therefore, the maximum energy Umax that can be accumulated by a mainspring with the length L is expressed by the following Eq. (7), wherein αmax is the maximum deflection angle of the mainspring 31 in FIG. 2.
Eq. 7
Umax=(bt³E/24L)×αmax² (7)

The bending stress σ applied to the mainspring 31 is expressed as a function of the bending moment applied to the mainspring 31, specifically, of the output torque T that can be outputted by the mainspring 31 in a deflected state. The bending stress σ is expressed by the following Eq. (8), wherein y is the displacement in the thickness direction from the neutral axis A of the mainspring 31, and Iz is the cross-sectional secondary moment of the mainspring 31.
Eq. 8
σ=T×y/Iz (8)

Therefore, using Eq. (8) allows the maximum bending stress σb in the tensile direction applied to the top surface of the mainspring 31 in FIG. 2 to be calculated according to the following Eq. (9).
Eq. 9
σb=T×(t/2)Iz (9)

Since the cross section of the mainspring 31 is a rectangular shape with a thickness t and a width b, then Iz can be determined by the following Eq. (10). Also, using Eqs. (9) and (10), the output torque T of the mainspring 31 can be determined according to the following Eq. (11).
Eq. 10
Iz=bt³/12 (10)
Eq. 11
T=(bt²/6)×σb (11)

Using Eqs. (1) and (11), the output torque T can then be calculated according to Eq. (12) shown below.
Eq. 12
T=(E t³bπ/6L)×N=(bt²/6)×σb (12)

Using Eq. (4), the maximum number of turns Nmax of the mainspring that gives αmax in Eq. (7) can be expressed by Eq. (13) shown below.
Eq. 13
Nmax=αmax/2π (13)

The relationship in Eq. (14) below for determining αmax can be derived from Eqs. (12) and (13).
Eq. 14
αmax=2Lσb/Et (14)

It can be seen, therefore, that αmax is determined by the maximum bending stress σb in the tensile direction of the mainspring 31, specifically, by the maximum tensile stress σmax of the mainspring material used for the mainspring 31, and that Eq. (7) can be derived from the Eq. (15) shown below.

$$Eq . 15 \\ \begin{matrix}U max = ( b {t}^{3} E / 24 L ) \times {( 2 L σ max / E t )}^{2} \\ = ( b t L / 6 ) \times ( σ {max}^{2} / E )\end{matrix} \qquad ( 15 )$$

It is clear from Eq. (15) that, the maximum energy Umax accumulated by the mainspring 31 in FIG. 2 varies according not only to the thickness t, width b, and length L of the mainspring 31, but also to the maximum tensile stress σmax and average Young's modulus E of the material constituting the mainspring 31.

Therefore, it is clear that a material with a high maximum tensile stress σmax and a low average Young's modulus E is preferably used as the mainspring 31 in order to increase the energy Umax accumulated by the mainspring.

Specifically, when a titanium alloy spring wherein σmax=1500 (MPa) and E=80 (GPa) is used as the material for the mainspring 31, it is clear from Eq. (15) that about 1.4 times the amount of energy is stored compared to conventional practice. It can be seen, therefore, that high precision and stable operation of the precision mechanisms of the timepiece can be ensured with the timepiece spring of the present invention when the spring is configured from a special titanium alloy with the aforementioned average Young's modulus and tensile strength. When the timepiece spring is used as a power source, long-term operation can be ensured.

Therefore, if a mainspring (titanium alloy mainspring) composed of a timepiece spring of a special titanium alloy is used as the source for powering the drive source of a timepiece or the like, it is possible to improve the volume density with which energy can be accumulated in the mainspring without varying the shape or dimensions of the barrel or other such components. Consequently, the mainspring can operate for a long time while maintaining a small size as a source for powering a drive mechanism. Such a mainspring is particularly preferable as a source for powering a drive source in a wristwatch, for which small size is vital.

In the above description, when a timepiece spring configured from the special titanium alloy previously described is used as a hairspring or a mainspring, the mainspring is preferably composed of nonmagnetic material.

Specifically, if the mainspring is configured from nonmagnetic material, its magnetic resistance is improved, so the characteristics of the mainspring are not affected even if the mainspring is stretched in a magnetic field or the like.

Also, when a spring configured from a special titanium alloy is used as a fixing spring for a quartz oscillator, a click spring, or the like, its magnetic resistance is improved and the urging force of the spring is similarly not affected by magnetic fields or the like as long as the spring is configured from a nonmagnetic material.

[Optimal Shape of Timepiece Spring Configured from Special Titanium Alloy]

The timepiece spring configured from a special titanium alloy is preferably endowed with initial deflection and incorporated into a base plate, ground plate, or the like.

Specifically, with the initial deflection, the spring does not move or become misaligned even when the spring is incorporated into a base plate, ground plate, or the like.

Furthermore, the presence of the initial deflection allows a load to be added in the initial phase. A spring made of a conventional material has a high average Young's modulus, so the margin for the allowable stress is proportionally reduced. Accordingly, a timepiece spring configured from a titanium alloy has a low average Young's modulus, so the margin for the allowable stress is adequately maintained even when a load is applied during initial deflection.

Also, the cross-sectional shape of the timepiece spring configured from a special titanium alloy is preferably a circle with a diameter of 0.05 mm or greater, or a rectangle with a thickness of 0.01 mm or greater and a width of 0.05 mm or greater.

Specifically, since a sufficient urging force is obtained when the timepiece spring has such a cross-sectional shape, the spring can be used as fixing means for a quartz oscillator, as a hairspring to urge a balance constituting the governor of a mechanical timepiece, or a mainspring that serves as the power source of a drive source.

Furthermore, the timepiece spring configured from a special titanium alloy is preferably formed into a rectangular cross section by drawing the titanium alloy and fashioning it into a wire.

Specifically, since the special titanium alloy constituting the timepiece spring of the present invention has excellent cold workability, it is mostly free of drawbacks such as work hardening and reduced ductility even when subjected to cold wire-drawing without annealing, and can be cold-worked to any extent. The angles in a cross section can therefore be rounded by fashioning a wire from a titanium alloy that has already been wire-drawn in the form of a rod. As a result, the load during sliding can be reduced.

When the spring configured from a special titanium alloy is used as a mainspring to power a drive source, the mainspring in a freely spread-out state takes on an S shape, and the inflection point at which the curving direction of this freely spread-out shape changes is preferably formed farther inward than the midpoint between the inner end at the winding side and the outer end at the end opposite the inner end.

The term “freely spread-out shape” of the mainspring herein refers to the spread-out state in which the mainspring is released from its restricted state, such as when the mainspring protrudes out of the barrel.

Also, the freely spread-out mainspring composed of conventional material is formed into an S shape similar to the ideal curvature in which the inflection point (the point at which the radius of curvature ρ is infinite and the curving direction of the mainspring changes) is formed at the midpoint C between the inner and outer ends of the mainspring, such as in the graph G3 shown in FIG. 3. This is because of the following reasons (d) and (e).

(d) The mainspring is curled in advance to the side opposite the winding direction, and a large amount of energy is accumulated in the mainspring during winding.

(e) Bending stress is uniformly applied over the entire mainspring to prevent the mainspring from rupturing due to stress accumulation.

As previously described, the mainspring that is configured from a special titanium alloy has a lower average Young's modulus than does a conventional mainspring material, so the restrictions brought about by the factors described in (e) are eased, and curling can still be provided in order to achieve the results described in (d).

Specifically, the optimal freely spread-out shape of the mainspring configured from a special titanium alloy is determined as follows.

Assuming that the spiral shape of the wound mainspring in the barrel is an Archimedean spiral, it is possible to express this shape with the aid of Eq. (16) shown below by using the polar coordinates r and θ. The symbol t is the thickness of the mainspring.
Eq. 16
r=(t/2π)×θ (16)

The conditions for the ideal curvature in which stress does not accumulate over the entire mainspring are given by Eq. (17), wherein M is the bending moment applied to the mainspring, B is the bending rigidity of the mainspring, ρ₀ is the radius of curvature of the mainspring in its freely spread-out shape, and ρ₁ is the radius of curvature of the external peripheral portion of the wound mainspring.
Eq. 17
(1/ρ₁)−(1/ρ₀)=M/B=constant (17)

The conditions in which the elastic energy stored in the entire mainspring is at its maximum are given by Eq. (18), wherein εmax is the maximum amount of elastic strain in the mainspring.
Eq. 18
B/M=t/4εmax (18)

Furthermore, the relationship in Eq. (19) is satisfied, wherein L′ is length of the mainspring measured along the curvature from the wound center.
Eq. 19
1/ρ₁=(π/tL′)^{1/2} (19)

Therefore, Eq. 20 shown below can be derived from Eqs. (17) and (19).
Eq. 20
1/ρ₀=(π/tL′)^{1/2}−M/B (20)

In practice, since the inner end of the mainspring is wound around the barrel stem, the actual length L of the mainspring is determined by Eq. (21), wherein r is the radius of the barrel stem.
Eq. 21
L=L′−πr²/t (21)

The intrinsic equation for the ideal curved shape is shown in Eq. (22) below.
Eq. 22
ρ₀=2(π/t)×(B/M)³×(1/L)+B/M (22)

Therefore, the radius of curvature ρ₀ of the freely spread-out mainspring when the stored energy is at its maximum can be expressed by Eq. (23) shown below, based on Eqs. (18) and (22).
Eq. 23
ρ₀=2(π/t)×(t/4εmax)³×(1/L)+t/4εmax (23)

When εmax is 0.02, the pitch of the spiral shape of the ideal curve is much less than the thickness t of the mainspring, and in practice this shape can be substituted by one close to εmax=0.02.

Graph G4 is a graphic representation of Eq. (23) in FIG. 3. Calculations show that an inflection point can form farther inward than in the graph G3 of a mainspring composed of conventional material.

Therefore, if the mainspring is configured from a special titanium alloy, the entire length of the mainspring can be curled to the side opposite the winding direction, making it possible to increase the energy stored while the mainspring is wound up.

The aforementioned Eq. (1) is a basic equation calculated theoretically, and Eq. (22) is also a theoretical equation determined from this basic equation. The result is that, in practice, friction occurs between mainsprings or between the mainspring and the barrel, and a winding allowance for joining the mainspring and the barrel must be provided, so these factors must be taken into account.

Therefore, the relationship between the number of turns N and the output torque T in a mainspring of conventional material is expressed by Eq. (24), wherein K₁ is the correction factor due to friction, and N₀ is the number of turns for winding the mainspring around the barrel stem.
Eq. 24
T=K₁·(Ebt³π/6L)×(N−N₀) (24)

Therefore, in comparison with the output torque characteristics G6 of a mainspring composed of conventional material, the output torque characteristics G5 of a mainspring configured from a special titanium alloy have the same number of turns but correspond to a gentler slope in the curve and to a reduction in the torque fluctuation brought about by variations in the number of turns, as shown in FIG. 4. Also, the duration is increased and the drive source can operate for a longer time because higher torque can be obtained by the same number of turns.

The mainspring is preferably curled by a heat treatment at a temperature of 150° C. or more.

Specifically, as previously described, since the special titanium alloy has both superelastic properties that provide the alloy with excellent elastic modification capabilities, and superplastic properties that provide the alloy with excellent cold workability even at room temperature, the mainspring sometimes returns to its original shape even when curled by normal methods. Consequently, the mainspring can be curled in a simple manner by taking the temperature characteristics of the tensile strength into account and curling the spring at a temperature of 150° C. or more, which is relatively low for such strength.

Also, when the timepiece spring configured from a special titanium alloy is used as a mainspring, the titanium alloy mainspring may be composed of a single plate manufactured by a specific manufacturing method, or the titanium alloy mainspring may be produced by laminating and integrating two, three, or a plurality of titanium alloy plate-shaped members. In the case of the latter, the titanium alloy mainspring is formed by laminating a plurality of titanium alloy plate-shaped members, and it is therefore possible to set freely the thickness t of the titanium alloy mainspring according to the output torque and other such required properties, as can be seen from Eqs. (1), (22), and (23).

Another feature of this arrangement is that when the plates are laminated and integrated, the plurality of titanium alloy plate-shaped members may be affixed using an epoxy resin or other such synthetic resin-based adhesive.

Such a laminated and integrated spring may be used as a fixing spring for a quartz oscillator, a click spring, or the like.

The timepiece of the present invention is characterized in that the previously described mainspring and/or hairspring of the present invention are/is used.

In the timepiece of the present invention, the effects of the mainspring and hairspring of the present invention can be suitably manifested.

### BEST MODE FOR CARRYING OUT THE INVENTION

Embodiments of the invention will now be described with reference to the drawings. As will be apparent from the disclosure of the present invention to those skilled in the art, the description of the invention embodiments is intended solely to illustrate the present invention and should not be construed as limiting the scope of the present invention, which is defined by the claims described below or by equivalent claims thereof.

### First Embodiment

The first embodiment relates to a drive source 1 wherein the timepiece spring according to the present invention is used as a mainspring.

FIG. 5 is a plan view showing the drive source 1 of an electronically controlled mechanical timepiece designed using a mainspring 31 (hereinafter occasionally referred to as “titanium alloy mainspring 31”) configured from a special titanium alloy in accordance with the present invention. FIGS. 6 and 7 are cross-sectional views thereof.

The drive source 1 of the electronically controlled mechanical timepiece includes a barrel 30 that is composed of a titanium alloy mainspring 31, a barrel gear 32, a barrel stem 33, and a barrel cover 34.

The outer end of the titanium alloy mainspring 31 is fixed to the barrel gear 32, while the inner end is fixed to the barrel stem 33. The barrel stem 33 is supported by a ground plate 2 and a train wheel bridge 3, and is fixed by a ratchet screw 5 so as to rotate integrally with a ratchet wheel 4. The ratchet wheel 4 meshes with a click 6 so as to rotate clockwise but not counterclockwise.

The method for rotating the ratchet wheel 4 clockwise and winding the titanium alloy mainspring 31 is the same as in the automatic winding or manual winding mechanism of a mechanical timepiece, so a description thereof is omitted.

The rotation of the barrel gear 32 is accelerated sevenfold, transmitted to a second wheel and pinion 7, accelerated 6.4 times, transmitted to a third wheel and pinion 8, accelerated 9.375 times, transmitted to a fourth wheel and pinion 9, accelerated threefold, transmitted to a fifth wheel and pinion 10, accelerated tenfold, transmitted to a sixth wheel and pinion 11, accelerated tenfold, and transmitted to a rotor 12, for a total acceleration of 126,000 times. These gears constitute a train wheel.

A cannon pinion 7a is fixed to the second wheel and pinion 7, a minute hand 13 is fixed to the cannon pinion 7a, and a seconds hand 14 is fixed to the fourth wheel and pinion 9. Therefore, the rotor 12 should be controlled so as to rotate at 5 rps in order to rotate the second wheel and pinion 7 at 1 rph and the fourth wheel and pinion 9 at 1 rpm. The barrel gear 32 in this case rotates at 1/7 rph.

This electronically controlled mechanical timepiece includes a power generator 20 configured from the rotor 12, a stator 15, and a coil block 16. The rotor 12 is configured from a rotor magnet 12a, rotor pinion 12b, and a rotor inertia disk 12c. The rotor inertia disk 12c is designed to reduce fluctuations in the rotational speed of the rotor 12 in relation to fluctuations in drive torque from the barrel 30. The stator 15 has 40,000 turns of a stator coil 15b wound around a stator body 15a.

The coil block 16 has 110,000 turns of a coil 16b wound around a magnetic core 16a. The stator body 15a and the magnetic core 16a herein are configured from PC Permalloy. Also, the stator coil 15b and the coil 16b are connected in series so as to produce an output voltage that is the sum of all generated voltages.

Though this is not shown in FIGS. 5 through 7, the alternating current voltage generated by such a power generator 20 is fed to a control circuit provided in order to control the speed adjustment, unidirectional slow motion, and other attributes of the drive source 1.

Next, the internal structure of the barrel 30 will be described based on FIG. 8.

FIG. 8(A) shows the titanium alloy mainspring 31 wound up in the barrel 30, and FIG. 8(B) shows the titanium alloy mainspring 31 after it has been unwound in the barrel.

The profile dimensions of the titanium alloy mainspring 31 can be set so that the width b is 1 mm, the thickness t is 0.1 mm, and the entire length L is 300 mm, for example.

Furthermore, the timepiece spring for forming the titanium alloy mainspring 31 may be formed into a rectangular cross section by drawing the titanium alloy and fashioning it into a wire.

As previously described, the titanium alloy mainspring 31 has an inner end 311 wound into a spiral shape around the barrel stem 33, and an outer end 312 bonded and fixed to the inner side of the barrel.

In the state shown in FIG. 8(B), the titanium alloy mainspring 31 is wound up when the barrel 30 is rotated around the barrel stem 33 by an external force. After the mainspring is wound up, the barrel 30 is released from its restricted state, and the barrel 30 is then rotated along with the unwinding of the titanium alloy mainspring 31.

The second wheel and pinion 7 and the rest of the train wheel are rotated by the barrel gear 32 formed on the outer periphery of the barrel 30, and the minute hand 13, seconds hand 14, and the like are caused to operate.

The titanium alloy mainspring 31 may be composed of a titanium alloy plate-shaped member 313 made from a single plate with a thickness t of 0.1 mm, for example; or may be formed by laminating and integrating a plurality of titanium alloy plate-shaped members 313 with a thickness of 50 μm as shown in FIG. 9, in which case the spring is configured by affixing the titanium alloy plate-shaped members 313 to each other with an epoxy-based adhesive 314.

Also, the titanium alloy mainspring 31 removed from the barrel 30 is curled around the barrel stem 33 to the side opposite the winding direction as shown in FIG. 10, and the spring has a freely spread-out shape in the form of a rough S in plan view.

The inflection point 315 where the curving direction changes is formed near the inner end 311, and this point is used to fix the titanium alloy mainspring 31 to the barrel stem 33 from the inflection point 315 up to the inner end 311.

When a titanium alloy mainspring 31 such as the one described above is formed, a titanium alloy plate-shaped member 313 that is composed of a single plate with a thickness t of 0.1 mm and that has been manufactured by a specific manufacturing method may be curled and used as the titanium alloy mainspring 31.

Also, in this case, the titanium alloy mainspring 31 may be curled by heat treatment at a temperature of 150° C. or greater.

When the titanium alloy mainspring 31 is formed from a plurality of titanium alloy plate-shaped members 313 such as those shown in FIG. 9, the titanium alloy plate-shaped members 313 are first fashioned to the width and length necessary for the source to power the drive source 1.

The special titanium alloy plate-shaped members 313 are then affixed to each other using an epoxy-based adhesive 314, and the thickness t necessary for the titanium alloy mainspring 31 (0.1 mm) is secured.

Finally, before the epoxy-based adhesive 314 has cured, the titanium alloy mainspring 31 is wound and curled into a rod shape or the like, and the epoxy-based adhesive 314 is then allowed to cure.

The following effects are obtained with the titanium alloy mainspring 31 according to the first embodiment described above.
(1) Since the titanium alloy mainspring 31 is employed as the source for powering the drive source 1, the drive source 1 can operate for a long time while the size of the drive mechanism 1 can be kept small.

It should be noted that when a conventional mainspring is incorporated into the drive source 1, the mainspring stops within 40 hours after winding, but when the titanium alloy mainspring 31 is thus incorporated, the mainspring stops within 45 hours after winding, which is an increase of about 10% in duration.
(2) Since the position of the inflection point 315 can be set near the inner end 311, curling can be performed over nearly the entire length of the titanium alloy mainspring 31, and the mechanical energy stored by the titanium alloy mainspring 31 can be increased to ensure an even longer-term operation for the drive source 1.

Also, since torque fluctuation is reduced with the titanium alloy mainspring 31, driving precision can be improved when the mainspring is used as a source for powering a mechanical timepiece.
(3) Conventional mainsprings having a specific thickness have been obtained by repeated rolling from bulk materials. With the titanium alloy mainspring 31, however, a wire, ribbon material, or the like can be easily manufactured by a single roll process, twin roll process, in-rotating-water spinning process, or other such methods, and therefore the manufacture of the titanium alloy mainspring 31 can be simplified.
(4) Since the curling of the titanium alloy mainspring 31 is performed by heat treatment at a temperature of 150° C. or greater, the mainspring 31 can be easily curled even when it is a titanium alloy having both superelastic properties and superplastic properties.
(5) Since the timepiece spring that forms the titanium alloy mainspring 31 is formed into a rectangular cross section by drawing the titanium alloy and fashioning it into a wire, the angles of the cross section can be rounded, making it possible to reduce the load during sliding.

The special titanium alloy that constitutes the timepiece spring of the present invention has excellent cold workability, and is hence substantially free of work hardening or reduced ductility even when subjected to cold wire drawing without annealing, and can be cold-worked to any extent.

Therefore, it is possible to fashion an already wire-drawn titanium alloy into a wire and to achieve successfully effects such as those described above.

### Second Embodiment

Next, a drive source 101 that utilizes the titanium alloy mainspring 31 according to the second embodiment of the present invention will be described.

In the following invention, descriptions are omitted or simplified for components that are identical or similar to components or members that have already been described.

In the drive source 1 according to the first embodiment previously described, the power source for operating the drive source 1 was composed of a single titanium alloy mainspring 31 housed in the barrel 30.

By contrast, the drive source 101, according to the second embodiment is different in that two barrels 30 are provided and that the titanium alloy mainsprings 31 housed inside each barrel function as sources for powering the drive source 101, as shown in FIG. 11.

As shown in FIG. 11, barrel gears 32 (not shown in FIG. 11) formed on the outer peripheries of the two barrels 30 simultaneously mesh with the base gear 71 of the second wheel and pinion 7 in the drive source 101 of the present embodiment.

The two barrels 30 both rotate in the same direction around the barrel stems 33, and an output torque 2T, which is the sum of the output torques T of the titanium alloy mainsprings 31, is applied to the second wheel and pinion 7.

The barrel gears 32 in meshing engagement with the second wheel and pinion 7 are designed so that the phases by which the left barrel gear 32 and the right barrel gear 32 mesh are different, and when the right barrel gear 32 is in contact with the second wheel and pinion 7 at point B1, the right barrel gear 32 moves away from the second wheel and pinion 7 at point B2, as shown in FIG. 12.

The difference is these phases is determined by the relative position of the barrel stems 33, and the meshing phases can be adjusted according to the angle β formed by the rotational center of the second wheel and pinion 7 and the barrel stems 33, as is clear in FIG. 11.

In addition to the effects described in the first embodiment, the following effects are obtained with the drive source 101 that uses a titanium alloy mainspring according to the second embodiment.

Specifically, since the two barrels 30 in which the titanium alloy mainsprings 31 are housed are made to mesh simultaneously with the second wheel and pinion 7 constituting the train wheel, the output torques T of the barrels 30 can be combined to rotate the second wheel and pinion 7, and the drive source 101 can be operated at a high output torque 2T.

The barrel gears 32 in meshing engagement with the second wheel and pinion 7 are out of phase with each other. For this reason, fluctuations in transmitted torque can be suppressed and the drive source 101 can be operated smoothly by adopting an arrangement in which torque fluctuations generated by the meshed state of, for example, the left barrel 30 and the second wheel and pinion 7 in FIG. 12 are harmonized with the torque according to the meshed state of the right barrel 30.

### Third Embodiment

Next, the third embodiment of the present invention will be described. In the third embodiment, the spring configured from the titanium alloy according to the present invention is used as a hairspring to urge a balance constituting the governor of a mechanical timepiece.

Specifically, a balance stud system 400 constituting the governor in the present embodiment is configured with a balance staff 410, a balance wheel 420, a roller with jewel 430, a stud ball 440, a stud 450, and a regulator 460, as shown in FIGS. 13 and 14.

The balance staff 410 shown in FIGS. 13 and 14 has the balance wheel 420, the roller with jewel 430, and the stud ball 440 fixed thereto, which are configured so as to rotate integrally. The hairspring 470 is a nonmagnetic member configured from a titanium alloy, whose inner end is fixed to the stud ball 440, and whose outer end is fixed to the stud 450. The regulator 460 is configured with a stud pin 461 and a stud support 462, and the outermost portion of the hairspring 470 passes between the stud pin 461 and the stud support.

The stud ball 440 rotates with the rotation of the balance wheel 420 about the balance staff 410 in this balance stud system 400, and so the urging force of the hairspring 470 is applied to the balance wheel 420. When this urging force and the inertial force of the balance wheel 420 become equal, the balance wheel 420 first stops rotating and then starts rotating in the opposite direction due to the urging force of the hairspring 470. Specifically, the balance wheel 420 repeatedly oscillates around the balance staff 410. The oscillation cycle of the balance wheel 420 can be varied by slightly adjusting the positions of the stud pin 461 and the stud support 462 of the regulator 460. Also, the oscillation cycle T varies according to the inertial moment J of the balance wheel 420 or another such rotating component as well as the material characteristics of the hairspring 470. The cycle is expressed by Eq. (25) shown below, wherein b is the width of the hairspring 470, t is the thickness, L is the mainspring length, and E is the average Young's modulus of the hairspring.
Eq. 25
T=2π×(12JL/Ebt³)^{1/2} (25)

The following effects are obtained with the third embodiment described above.

Specifically, since the hairspring 470 is configured from a special titanium alloy, variations in the average Young's modulus E that accompany temperature variations are small, variations in the oscillation cycle of the balance stud system 400 as expressed by Eq. (25) are also small, and high precision can be ensured in a mechanical timepiece having a governor that includes the balance stud system 400.

Also, since the hairspring 470 is configured from a nonmagnetic titanium alloy, antimagnetic properties are improved, and there is no reduction in the mainspring characteristics even when the hairspring 470 is stretched in an external magnetic field or the like.

### Fourth Embodiment

Next, the fourth embodiment of the present invention will be described. In the fourth embodiment, a spring configured from an amorphous metal according to the present invention is utilized as a spring for fixing the quartz oscillator of a quartz oscillator timepiece in an urged state.

Specifically, a quartz oscillator 500 is configured with a vacuum capsule 501 and an oscillator main body 502 in the form of a tuning fork inside the vacuum capsule 501, and a terminal 503 provided to the end of the vacuum capsule 501 is electrically connected to a circuit board 510 to form an oscillation circuit, as shown in FIG. 15.

Such a quartz oscillator 500 is disposed on a ground plate 520 and is fixed by a screw 530 and a fixing spring 540 configured from a special titanium alloy while kept in a state of being urged in a direction in which the oscillator is pushed against the ground plate 520.

The following effects are obtained with the fourth embodiment.

Specifically, the fixing spring 540 configured from a special titanium alloy has a low average Young's modulus, so the relationship between the amount of deflection and the urging force of the fixing spring 540 describes a graph G2 whose slope is gentler than that of a graph G1 described by a spring made of a conventional material, as shown in FIG. 1.

Therefore, variations in the deflection of the fixing spring 540 produce only minimal fluctuation in the corresponding urging force, making it possible to reduce deviations in the cycle of the quartz oscillator, and allowing a high-precision quartz oscillator timepiece to be obtained.

The present invention is not limited to the embodiments previously described and includes modifications such as those described below. Specifically, in the first embodiment, the titanium alloy mainspring 31 was used as a source for powering a drive source 1 in an electronically controlled mechanical timepiece, but the titanium alloy mainspring 31 is not limited thereto can may also be used in a drive source of a regular mechanical timepiece wherein the control system is configured from a governor or an escapement.

In the second embodiment, two barrels 30 were kept in meshed engagement with the second wheel and pinion 7 that constituted the train wheel, but more than two barrels 30 may also be kept in meshed engagement. In short, the number of barrels should be appropriately determined according to the energy stored by the titanium alloy mainspring and the energy required by the source used to power the drive source.

In the fourth embodiment, the spring configured from a titanium alloy was used as the fixing spring 540 used for fixing the quartz oscillator 500, but this is not the only possible option.

Specifically, the click spring constituting the click 6 that meshes with the ratchet wheel 4 in the first embodiment may be configured from a special titanium alloy. The click 6 is a component designed to prevent the mainspring in the barrel from unwinding when it is to be wound, and the click spring is the spring used for this purpose. While the mainspring is wound, the click spring is repeatedly subjected to a load proportionate to the number of teeth by which the ratchet wheel meshes with the click, and the number of turns thereof is anywhere from ten thousand to several hundred thousand per year.

When such a load is repeatedly applied, the allowable stress of the click spring must be set to half the maximum stress or less. Therefore, if a spring configured from a titanium alloy is used for this click spring, the allowable stress can be set high, and this spring can be efficiently used as material for a click spring because there is little deviation in its urging force.

Also, in the embodiments previously described, the titanium alloy mainspring 31 was used as the source for powering the drive source 1 of a timepiece, but the titanium alloy mainspring 31 is not limited to this option alone and may also be used as a source for powering the drive source of a music box or the like.

The timepiece spring of the present invention itself can also be applied to precision mechanisms for music boxes and the like, in addition to timepieces. The timepiece spring of the present invention and the titanium alloy mainspring 31 may also be applied to low-torque timepieces.

Additionally, the specific structures, shapes, and other aspects obtained when the present invention is implemented may be configured differently as long as other objects can be attained.

### FIELD OF INDUSTRIAL APPLICABILITY

As described above, the timepiece spring, mainspring, hairspring, and timepiece according to the present invention can be suitably utilized, for example, as a source to power the drive source of a timepiece or the like, as a spring to fix a quartz oscillator in a quartz oscillator timepiece or the like, as a hairspring to urge a balance in a mechanical timepiece, or as a click spring to prevent a mainspring in a barrel from unwinding when the mainspring is being wound.

### BRIEF DESCRIPTION OF THE DRAWINGS

FIG. 1, which describes the operation of the present invention, is a graph showing the relationship between strain and urging force;

FIG. 2 is a schematic view illustrating operation of the present invention;

FIG. 3 is a graph showing the location of an inflection point of a mainspring on the basis of the relationship between the mainspring length and the radius of curvature;

FIG. 4 is a graph showing the relationship between the number of turns and the output torque;

FIG. 5 is a plan view showing a drive source obtained using a titanium alloy mainspring according to a first embodiment of the present invention;

FIG. 6 is a cross-sectional view of the drive source of the first embodiment;

FIG. 7 is another cross-sectional view of the drive source of the first embodiment;

FIG. 8 is a plan view showing the mainspring housed in a barrel of the first embodiment;

FIG. 9 is a cross-sectional view in the width direction of the mainspring of the first embodiment;

FIG. 10 is a plan view showing the freely spread-out shape of the mainspring of the first embodiment;

FIG. 11 is a partial plan view showing a drive source according to a second embodiment of the present invention;

FIG. 12 is a partial plan view showing the meshed state of a barrel and train wheel of the second embodiment;

FIG. 13 is a plan view showing the structure of a balance stub system according to a third embodiment;

FIG. 14 is a cross-sectional view showing the structure of the balance stub system of the third embodiment; and

FIG. 15 is a side view showing a fixed structure of a quartz oscillator according to a fourth embodiment of the present invention.

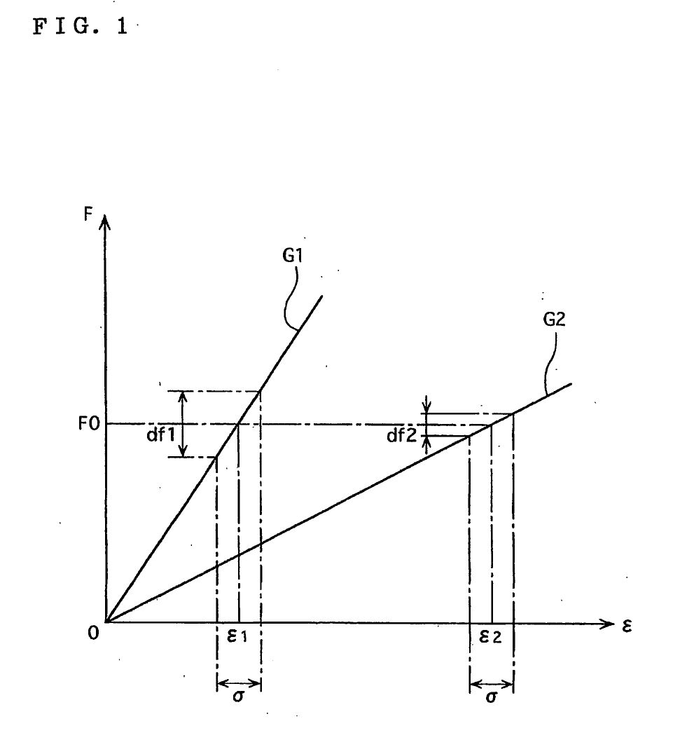

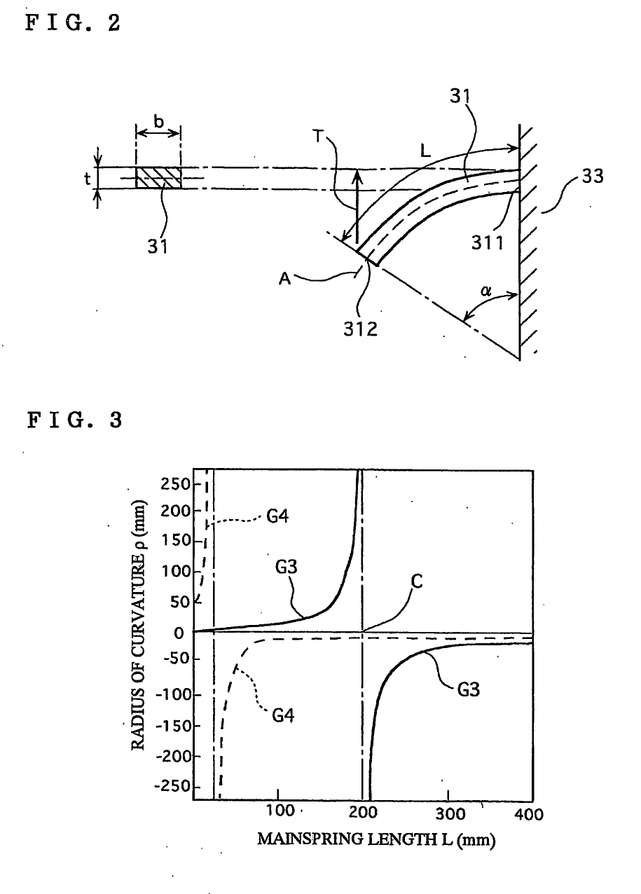

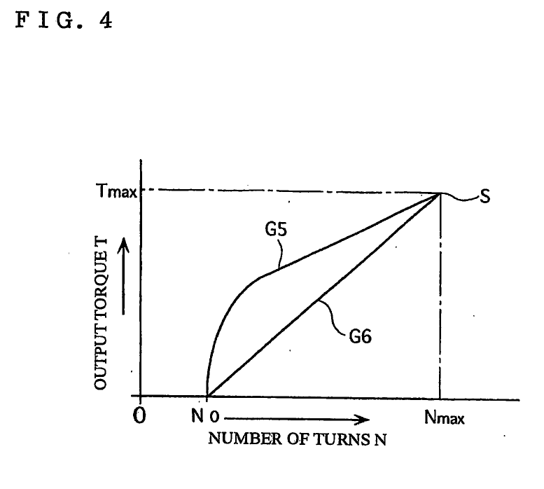

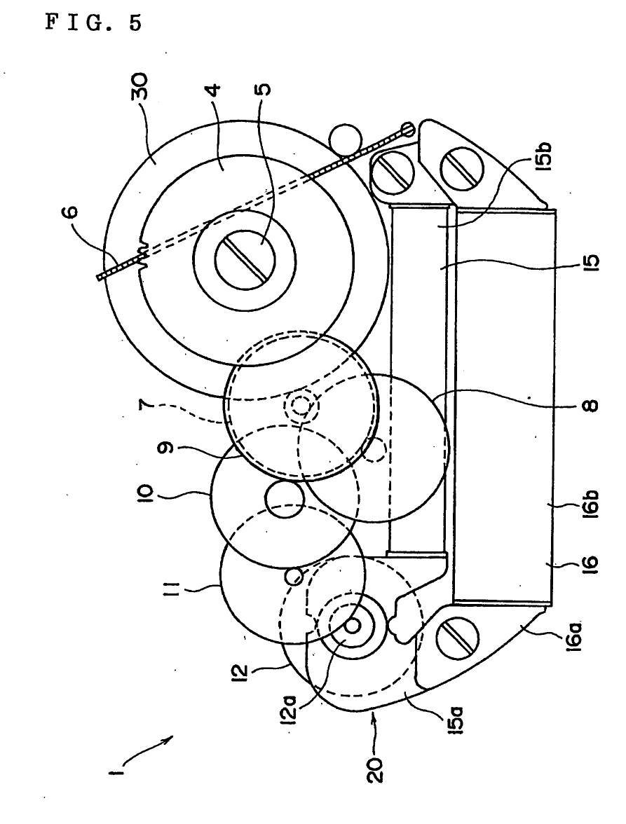

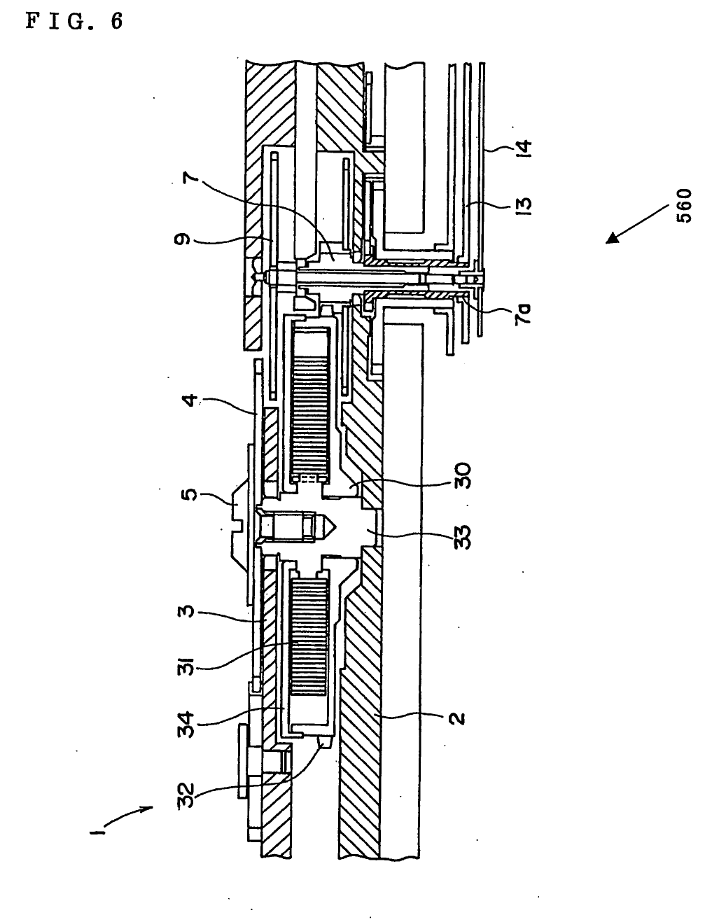

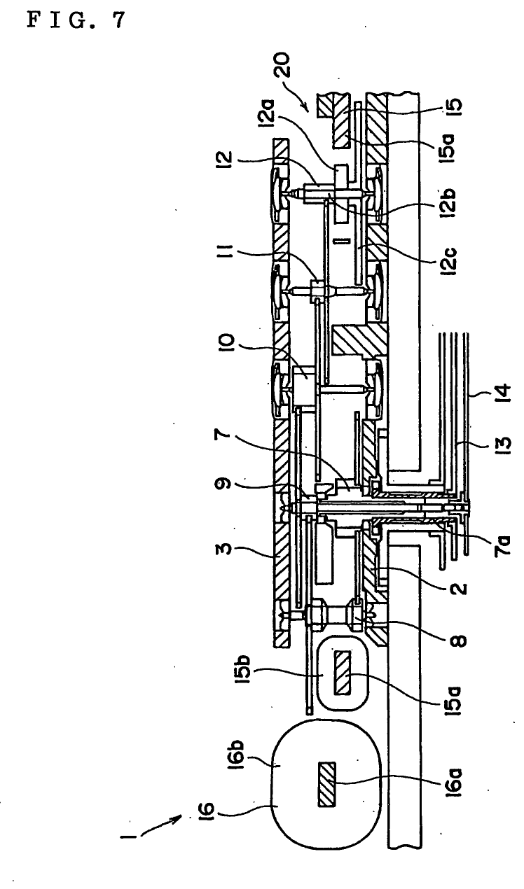

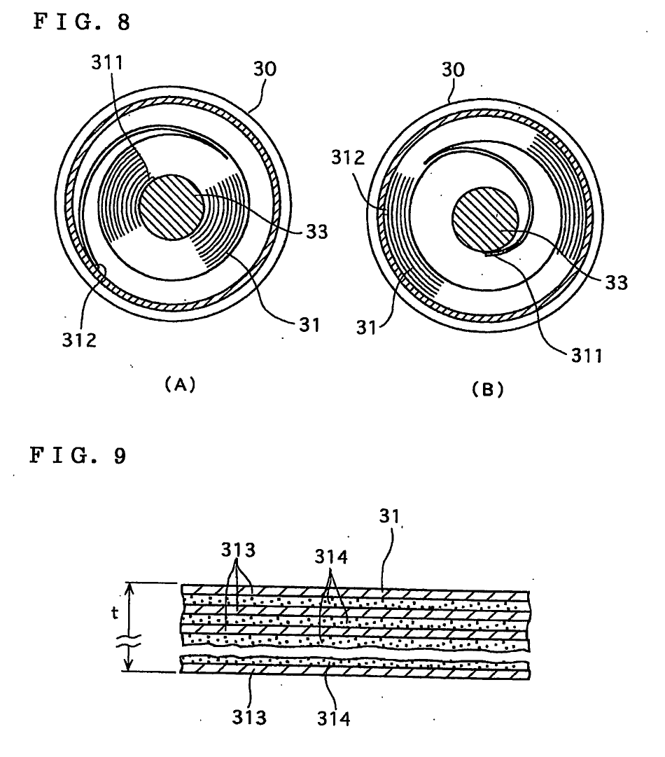

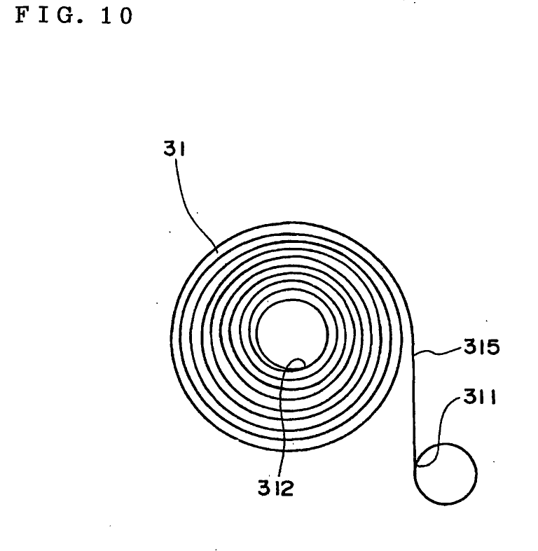

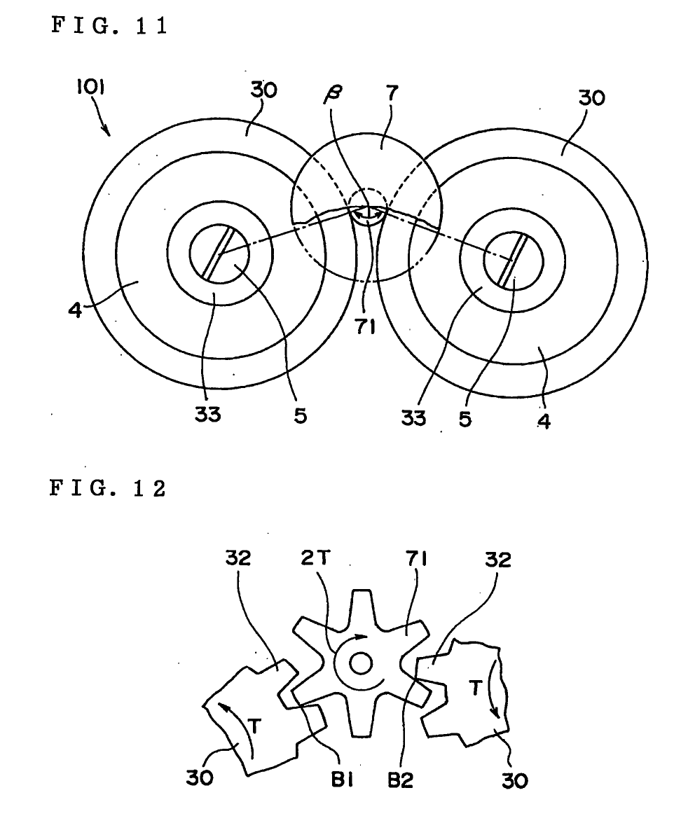

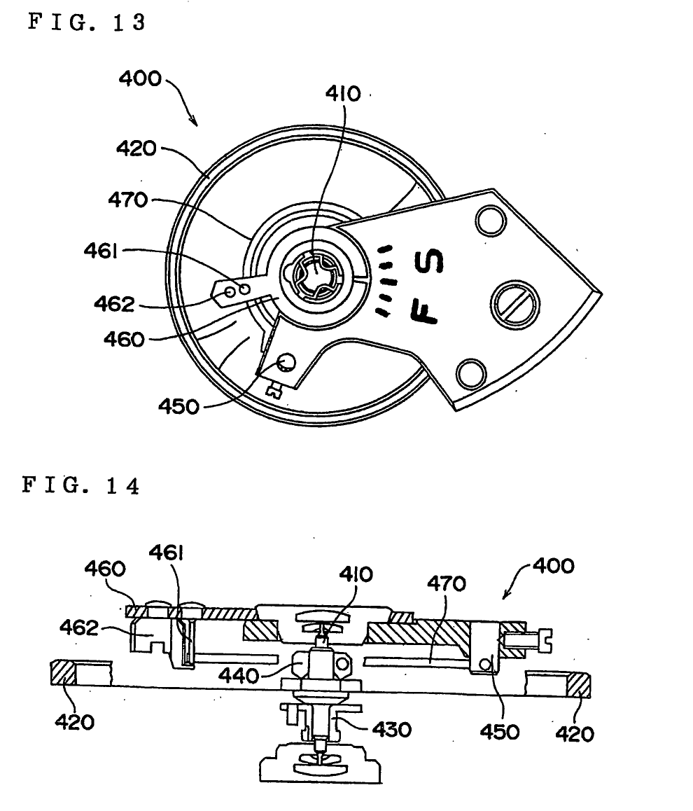

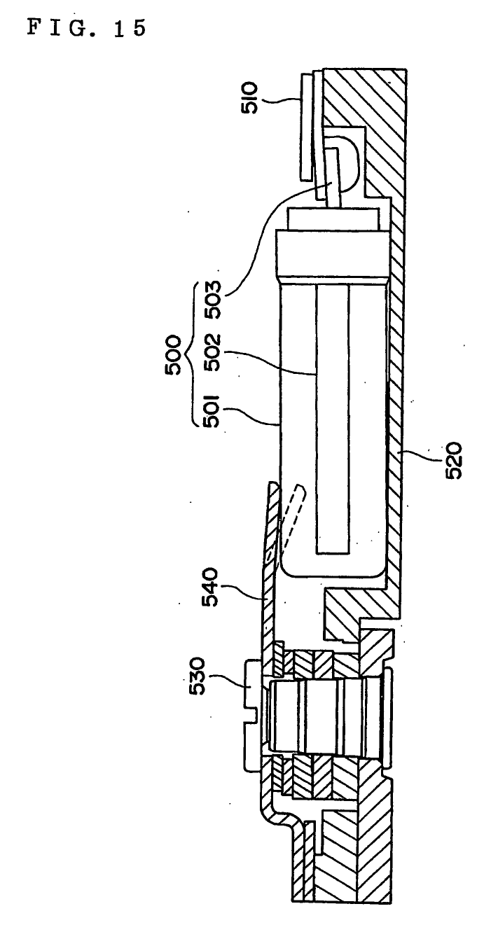

The terms “front,” “back, “up,” “down,” “perpendicular,” “horizontal,” “slanted,” and other direction-related terms used above indicate the directions in the diagrams used. Therefore, the direction-related terminology used to describe the present invention should be interpreted in relative terms as applied to the diagrams used. “Substantially,” “essentially,” “about,” and other terms that are used above and represent an approximation indicate a reasonable amount of deviation that does not bring about a considerable change as a result. Terms that represent these approximations should be interpreted so as to include a minimum error of about ±5%, as long as there is no considerable change due to the deviation.

The embodiments described above are only some of possible embodiments of the present invention, but it is apparent to those skilled in the art that it is possible to add modifications to the above-described embodiments by using the above-described disclosure without exceeding the range of the present invention as defined in the claims. The above-described embodiments furthermore do not limit the range of the present invention, which is defined by the accompanying claims or equivalents thereof, and are designed solely to provide a description of the present invention.

### KEY

1, 101: drive source, 2, 520: ground plate, 3: train wheel bridge, 4: ratchet wheel, 5: ratchet screw, 6: click, 7: second wheel and pinion, 8: third wheel and pinion, 9: fourth wheel and pinion, 10: fifth wheel and pinion, 11: sixth wheel and pinion, 12: rotor, 12a: rotor magnet, 12c: rotor inertia disk, 13; minute hand, 14: seconds hand, 15: stator, 15a: stator body, 15b: stator coil, 16: coil block, 16a: magnetic core, 16b: coil, 20: power generator, 30: barrel, 31: titanium alloy mainspring, 32: barrel gear, 33: barrel stem, 34: barrel cover, 71: base gear, 311: inner end, 312: outer end, 313: titanium alloy plate-shaped member, 314: epoxy-based adhesive, 315: inflection point, 400: balance stud system, 410: balance staff, 420: balance wheel, 430: roller with jewel, 440: stud ball, 450: stud, 460: regulator, 461: stud pin, 462: stud support, 470: hairspring, 500: quartz oscillator, 501: vacuum capsule, 502: oscillator main body, 503: terminal, 510: circuit board, 530: screw, 540: fixing spring, 560: time display 560

1. A timepiece comprising:
a time display to display time information; and
a driving power source driving said time display and having a spring including a titanium alloy containing one or more vanadium group (Group Va) elements with an average Young's modulus of 100 GPa or less and a tensile strength of 1000 MPa or greater.

2. The timepiece according to claim 1, wherein said spring has a circular cross section with a diameter of 0.05 mm or greater.

3. The timepiece according to claim 1, wherein said spring has a rectangular cross section with a thickness of 0.01 mm or greater and a width of 0.05 mm or greater.

4. The timepiece according to claim 1, wherein said spring is made of nonmagnetic material.

5. The timepiece according to claim 1, wherein said spring is a mainspring whose freely spread-out shape is an S shape.

6. The timepiece according to claim 5, wherein said spring has an inner end at an end of a winding side, and an outer end at the other end, and
said S shape has an inflection point at which a curving direction changes and which is formed farther inward than a midpoint between said inner end and said outer end.

7. The timepiece according to claim 6, wherein said power source has a barrel stem to which said inner end is fixed, a barrel gear to which said outer end is fixed, and a power generator having a rotor that is rotatably driven in conjunction with said barrel gear.

8. The timepiece according to claim 1, wherein said titanium alloy contains 20 to 80 mass % of said vanadium group elements per a total of 100 mass % of said titanium alloy.

9. The timepiece according to claim 8, wherein said titanium alloy contains 30 to 60 mass % of said vanadium group elements per a total of 100 mass % of said titanium alloy.

10. The timepiece according to claim 1, wherein said titanium alloy contains one or more metal elements from the group consisting of zirconium Zr, hafnium Hf, and scandium Sc.

11. The timepiece according to claim 10, wherein said titanium alloy contains 30 to 60 mass % of said metal element groups per a total of 100 mass % of said titanium alloy.

12. The timepiece according to claim 1, wherein said titanium alloy contains one or more of the elements oxygen O, carbon C, and nitrogen N.

13. The timepiece according to claim 12, wherein said titanium alloy contains 2 mass % or less of one or more of the elements oxygen O, carbon C, and nitrogen N per a total of 100 mass % of said titanium alloy.

14. The timepiece according to claim 1, wherein said titanium alloy contains boron (B).

15. The timepiece according to claim 14, wherein said titanium alloy contains 2 mass % or less of boron B per a total of 100 mass % of said titanium alloy.

16. The timepiece according to claim 1, wherein said titanium alloy contains one or more metal elements from the group consisting of chromium Cr, molybdenum Mo, manganese Mn, iron Fe, cobalt Co, nickel Ni, tin Sn, and aluminum Al.

17. The timepiece according to claim 1, wherein said average Young's modulus is 60 GPa or less, and said tensile strength is 1000 MPa or greater.

18. The timepiece according to claim 1, wherein said spring is configured from a single plate.

19. The timepiece according to claim 1, wherein said spring is configured from a laminated plate wherein a plurality of titanium alloy plate-shaped members is laminated and integrated.

20. A timepiece comprising:
a time display to display time information; and
a power source driving said time display and having a first and second spring including a titanium alloy containing one or more vanadium group (Group Va) elements, with an average Young's modulus of 100 GPa or less and a tensile strength of 1000 MPa or greater, said first and second springs jointly drive the time display.

21. The timepiece according to claim 20, said titanium alloy contains 20 to 80 mass % of the vanadium group elements per a total of 100 mass % of the titanium alloy.

22. The timepiece according to claim 20, wherein said titanium alloy contains one or more metal elements from the group consisting of zirconium Zr, hafnium Hf, and scandium Sc.

23. The timepiece according to claim 20, wherein said titanium alloy contains one or more of the elements oxygen O, carbon C, and nitrogen N.

24. A timepiece comprising:
a time display to display time information; and
a power source driving said time display and having a balance staff, a balance wheel being fixed to said balance stem, a roller with jewel and stud ball, a hairspring having an inner end being fixed to said stud ball, and a stud support being fixed to an outer end of said hairspring, said hairspring including a titanium alloy containing one or more vanadium group (Group Va) elements, with an average Young's modulus of 100 GPa or less and a tensile strength of 1000 MPa or greater.

25. The timepiece according to claim 24, wherein said titanium alloy contains 20 to 80 mass % of the vanadium group elements per a total of 100 mass % of the titanium alloy.

26. The timepiece according to claim 24, wherein said titanium alloy contains one or more metal elements from the group consisting of zirconium Zr, hafnium Hf, and scandium Sc.

27. The timepiece according to claim 24, wherein said titanium alloy contains one or more of the elements oxygen O, carbons C, and nitrogen N.

28. A timepiece comprising:
a time display to display time information; and
a power source driving said time display and having a quartz oscillator, a ground plate, and a spring fixing said quartz oscillator to said ground plate, said spring including of a titanium alloy containing one or more vanadium group (Group Va) elements, with an average Young's modulus of 100 GPa or less and a tensile strength of 1000 MPa or greater.

29. The timepiece according to claim 28, wherein said titanium alloy contains 20 to 80 mass % of the vanadium group elements per a total of 100 mass % of the titanium alloy.

30. The timepiece according to claim 28, wherein said titanium alloy contains one or more metal elements from the group consisting of zirconium Zr, hafnium Hf, and scandium Sc.

31. The timepiece according to claim 28, wherein said titanium alloy contains one or more of the elements oxygen O, carbon C, and nitrogen N.
